(19) United States
(12) Patent Application Publication
(10) Pub. No.: US 2018/0301772 A1
(43) Pub. Date: Oct. 18, 2018

(54) POWER STORAGE UNIT

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Kyohei Morita, Yokkaichi, Mie (JP); Tatsuya Sumida, Yokkaichi, Mie (JP)

(21) Appl. No.: 15/767,382

(22) PCT Filed: Oct. 4, 2016
(86) PCT No.: PCT/JP2016/079424

§ 371 Date: Apr. 11, 2018

(30) Foreign Application Priority Data
Oct. 27, 2015 (JP) 2015-210683

(51) Int. Cl. H01M 10/6551; H01G 11/10; H01G 2/04; H01G 11/18; H01M 10/613; H01M 10/625; H01M 10/653; H01M 2/10; H01M 2/34

(52) U.S. Cl. CPC H01M 10/6551; H01G 11/10; H01G 2/04; H01G 11/18; H01M 2/34; H01M 10/625; H01M 10/653; H01M 2/1016; H01M 10/613

(57) ABSTRACT

A power storage unit includes a power storage module that has multiple power storage elements, a heat dissipation member that is overlaid on the power storage module, and stud bolts that electrically connected an external circuit and the power storage module. The stud bolts pass through the heat dissipation member and are arranged outside. It is therefore possible to improve efficiency in the operation of connecting the external circuit and the stud bolts.

### CROSS-REFERENCE TO RELATED APPLICATIONS

This application is the U.S. national stage of PCT/JP2016/079424 filed Oct. 4, 2016, which claims priority of Japanese Patent Application No. JP 2015-210683 filed Oct. 27, 2015.

### TECHNICAL FIELD

The technology disclosed in the present specification relates to a power storage unit that includes multiple power storage elements.

### BACKGROUND

Conventionally, JP 2005-94943A is known as a capacitor unit that includes multiple capacitors. This capacitor unit includes a capacitor block that has multiple capacitors, and a control circuit portion that is constituted by a charging/discharging circuit for performing charging or discharging of the capacitor block. The capacitor unit and the control circuit portion are housed in a case. A heat dissipation plate, which is for suppressing the generation of heat by circuit components when charging and discharging is performed, is arranged on the control circuit portion. In order to improve the heat dissipation capability, it is conceivable to arrange the heat dissipation plate outside of the case.

However, even if the heat dissipation plate is arranged outside of the case, due to the fact that the heat dissipation plate is metallic, there are concerns regarding the arrangement of terminals via which power from a capacitor unit arranged inside the case is extracted to the outside.

In regards to this, JP 4758861B discloses a terminal block that is constituted by a non-conducting resin and is fixed to a heat sink via an electrically conductive fixing portion.

However, even with the configuration disclosed in Patent Document 2, the terminal block is attached to a surface of the heat dissipation plate, and therefore it has been difficult to provide a circuit from the inside of the case to the outside. For this reason, with respect to external terminals for electrically connecting an external circuit and a power storage module to each other, it has been difficult to arrange the external terminals at positions that enable easy attachment to the external circuit.

The technology disclosed in the present specification was achieved in light of the foregoing situation, and an object thereof is to provide a power storage unit that improves efficiency in the operation of attachment to an external circuit.

### SUMMARY

The technology disclosed in the present specification pertains to a power storage unit including: a power storage module that includes a plurality of power storage elements; a heat dissipation member that is overlaid on the power storage module; and an external connection terminal that electrically connects an external circuit and the power storage module, wherein the external connection terminal passes through the heat dissipation member and is arranged outside.

According to the above configuration, the external connection terminal passes through the heat dissipation member and is arranged outside. It is therefore possible to improve efficiency in the operation of connecting the external circuit and the external connection terminal.

The following aspects are preferable as aspects for carrying out the technology disclosed in the present specification.

The power storage unit further includes a control portion that controls charging and discharging of the power storage module, the control portion includes a connector for connection to the external circuit, and connection directions of the connector and the external connection terminal are the same.

According to the above configuration, the operations of electrically connecting the control portion and the power storage module to the external circuit can be performed from the same side. Accordingly, the operation of electrically connecting the external circuit and the power storage unit can be performed efficiently.

The control portion includes a relay portion that is connected to the external connection terminal.

According to the above configuration, the control portion and the power storage module can be electrically connected by connecting the relay portion to the external connection terminal.

A through-hole that passes through the heat dissipation member is formed in the heat dissipation member, an insulation member made of an insulating material is attached inside the through-hole, and the external connection terminal and the heat dissipation member are electrically insulated from each other by the insulation member.

According to the above configuration, the external connection terminal and the heat dissipation member can be reliably insulated from each other.

The heat dissipation member is assembled together with a holding member, and the insulation member has a guide portion that guides the heat dissipation member to an appropriate position relative to the holding member by sliding against the holding member.

According to the above configuration, the relatively heavy heat dissipation member can be easily attached to the holding member.

A plurality of the insulation members are provided, the insulation members are each provided with a hinge, and a terminal cover that covers the external connection terminal is attached to each of the hinges, and the hinges are provided at positions on the insulation members that are toward a center of the heat dissipation member.

According to the above configuration, the terminal covers expose or obstruct the external connection terminals by rotating about the hinges that are arranged at positions on the insulation members that are toward the center of the heat dissipation member. According to this configuration, the rotation axes of the terminal covers are provided toward the center of the heat dissipation member, thus facilitating the operation of opening and closing the terminal covers, which makes it possible to improve efficiency in the operation of connecting the external connection terminals and the external circuit.

According to the technology disclosed in the present specification, it is possible to improve the heat dissipation capability of a power storage unit, and it is possible to improve efficiency in the operation of connecting the power storage unit and an external circuit.

### BRIEF DESCRIPTION OF DRAWINGS

FIG. 1 is a perspective view showing a power storage unit according to a first embodiment.

FIG. 2 is a plan view showing the power storage unit.

FIG. 3 is a cross-sectional view taken along III-III in FIG. 2.

FIG. 4 is a cross-sectional view taken along IV-IV in FIG. 2.

FIG. 5 is a cross-sectional view taken along V-V in FIG. 2.

FIG. 6 is a cross-sectional view taken along VI-VI in FIG. 2.

FIG. 7 is a front view showing the power storage unit.

FIG. 8 is a perspective view showing a heat dissipation member.

FIG. 9 is a perspective view showing an insulation member in a state where a terminal cover is closed.

FIG. 10 is a perspective view showing the insulation member in a state where the terminal cover has not been attached.

FIG. 11 is a perspective view showing a holding member.

FIG. 12 is a plan view showing the holding member.

FIG. 13 is a bottom view showing the holding member.

### DETAILED DESCRIPTION OF PREFERRED EMBODIMENTS

### First Embodiment

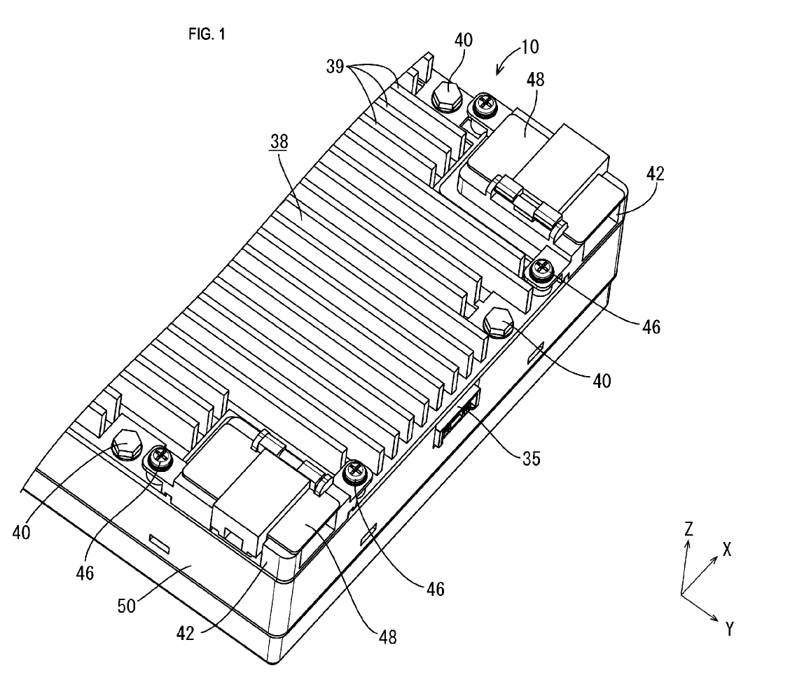

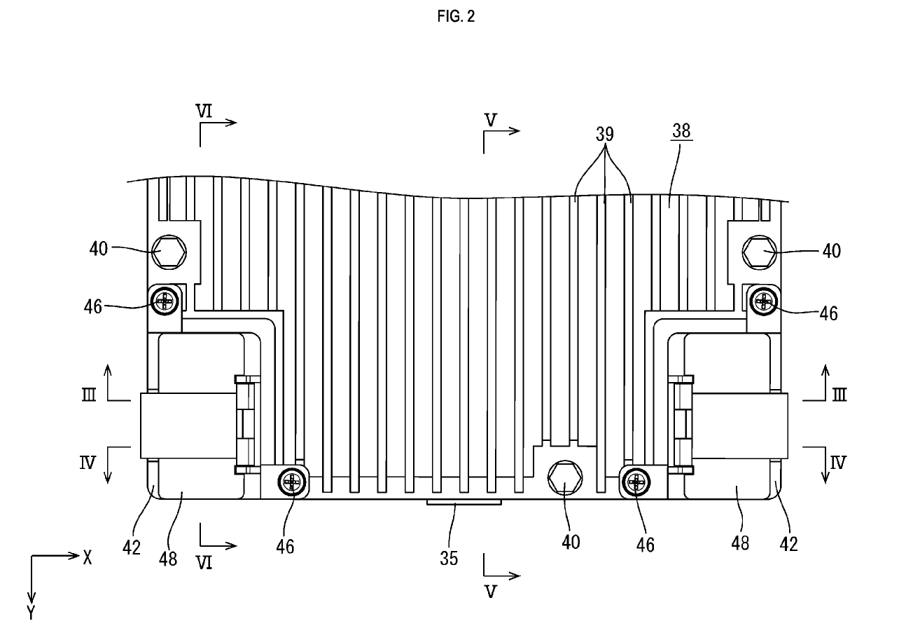

A first embodiment will be described below with reference to FIGS. 1 to 13. A power storage unit 10 (FIG. 1) is for installation in a vehicle (not shown) such as an electric automobile or a hybrid automobile, for example. A power supply path for connecting a main power supply, which is constituted by a battery or the like, to a load, which is constituted by a drive motor or an in-vehicle electrical component such as a lamp, is arranged in the vehicle. The power storage unit 10 is connected to the power supply path, and can be used as a charging/discharging control apparatus and an auxiliary power supply during engine idling stop and engine restart, for example.

In the following description, the X direction in FIG. 1 is considered to be the rightward direction, the Y direction is considered to be the forward direction, and the Z direction is considered to be the upward direction. Furthermore, in the case of members that are the same as each other, there are cases where only some of the members are denoted by reference signs, and the other members are not denoted by reference signs.

Power Storage Unit 10

The power storage unit 10 includes a power storage module 11 that has multiple (four in the present embodiment) power storage elements 12, a heat dissipation member 38 that is exposed to the outside, a control portion 30 that is arranged between the power storage module 11 and the heat dissipation member 38, and stud bolts 80 (one example of an external connection terminal) that are electrically connected to the power storage module 11 and are for electrical connection to an external circuit. The heat dissipation member 38 is overlaid on the power storage module 11 via the control portion 30.

Power Storage Module 11

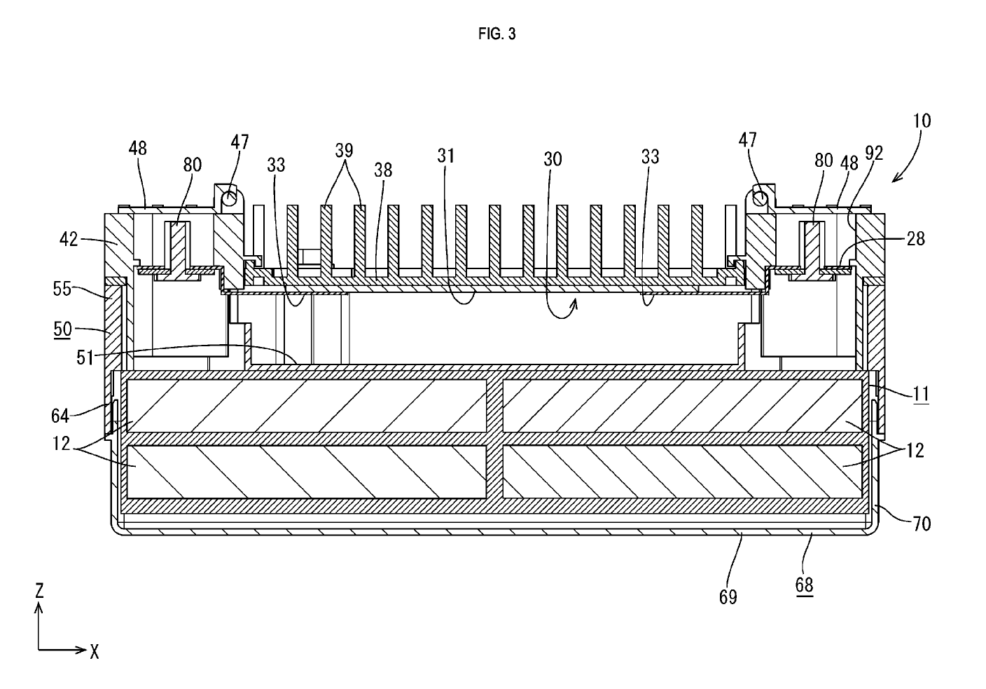

As shown in FIG. 3, the power storage module 11 includes multiple (four in the present embodiment) power storage elements 12 that are used as an auxiliary power supply having a smaller capacity than a main power supply, a power storage element case 16 that is made of a synthetic resin and houses the power storage elements 12, and connection members 25 that are made of a metal and connect electrode terminals (not shown) to each other.

The power storage elements 12 are arranged in the power storage element case 16 in two rows vertically, and each have a pair of electrode terminals that protrude perpendicularly from respective end surfaces of a main body portion (not shown) that has a flattened cuboid shape and houses the power storage element therein. Electrode terminals having unlike poles are connected together by the connection members 25 such that the power storage elements 12 are connected in series overall.

The connection members 25 are constituted by a metal plate member made of a copper alloy or the like, and are connected to the electrode terminals using a known technique such as the use of nuts.

Control Portion 30

The control portion 30 controls charging or discharging with respect to the power storage module 11. More specifically, the control portion 30 detects the state of the power storage elements 12 and controls the charging state or discharging state of the power storage elements in accordance with the state of the power storage elements 12, and has the functionality of a DC-DC converter, an inverter, or the like. The control portion 30 includes a circuit board 31, electronic components (not shown) that are mounted on the circuit board 31, and a connector 35 (one example of a connector) that is electrically connected to the circuit board 31.

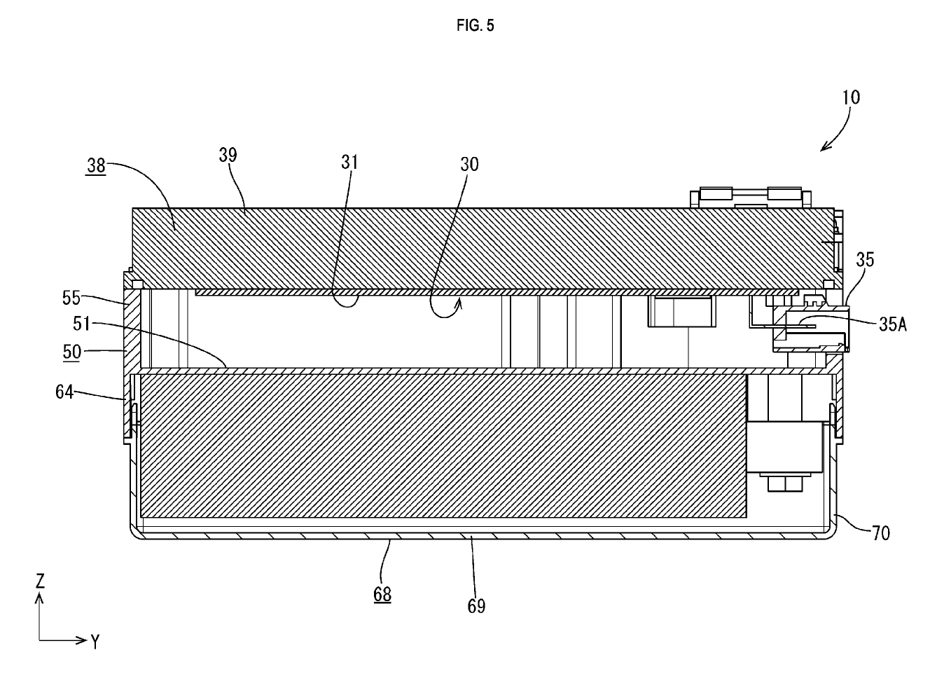

As shown in FIGS. 3 and 5, a conductive path (not shown) is printed on an insulated board of the circuit board 31. Bus bars 33 are connected to the conductive path of the circuit board 31. A flat surface of the heat dissipation member 38 is fixed to the surface of the circuit board 31 that is on the side opposite to the side on which the bus bars 33 are connected. Electronic components (not shown) are connected to the conductive path of the circuit board 31.

Although not shown in detail, the connector 35 is electrically connected to the conductive path of the circuit board 31 by a known technique such as soldering.

Heat Dissipation Member 38

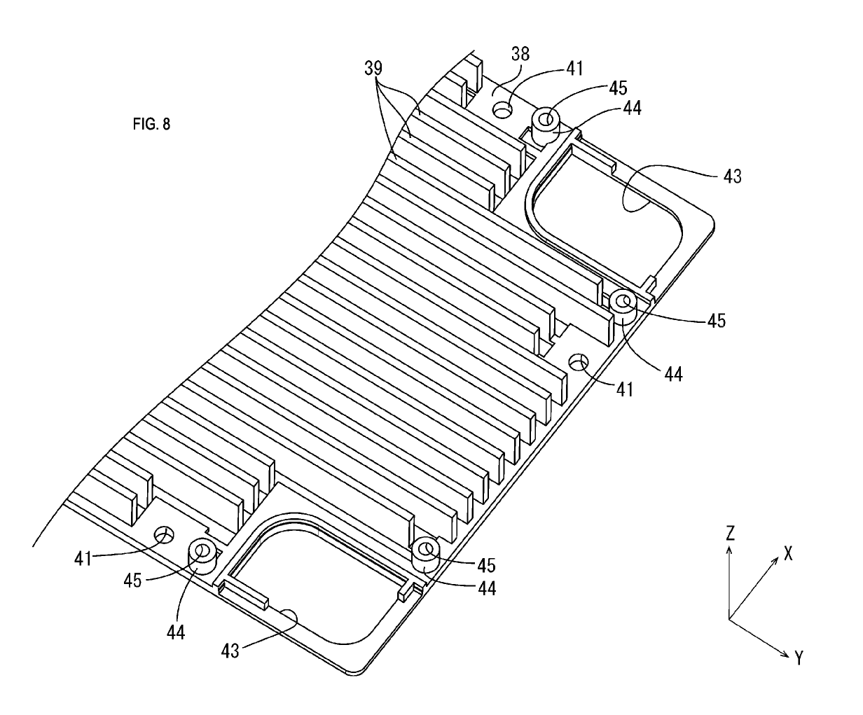

As shown in FIG. 8, the heat dissipation member 38 is made of a metal material that has high thermal conductivity such as an aluminum alloy or a copper alloy, is flat on the lower surface side, and includes a large number of radiating fins 39 that are arranged side-by-side on the upper surface side. The radiating fins 39 are exposed to the outside. Heat generated by the circuit board 31 when energized is conducted from the heat dissipation member 38 to the outside. The heat dissipation member 38 is provided with multiple insertion holes 41 for screw-fastening to the holding member 50 with metal screws 40.

Through-holes 43 for insertion of insulation members 42 are respectively formed at positions toward the left and right end portions of the front end portion of the heat dissipation member 38. The radiating fins 39 are not formed in the periphery of the through-holes 43.

Two bosses 44 project upward in the periphery of each of the through-holes 43. Threaded holes 45 are formed in the bosses 44. The insulation members 42 and the heat dissipation member 38 are fixed by screwing screws 46 into the threaded holes 45.

Insulation Members 42

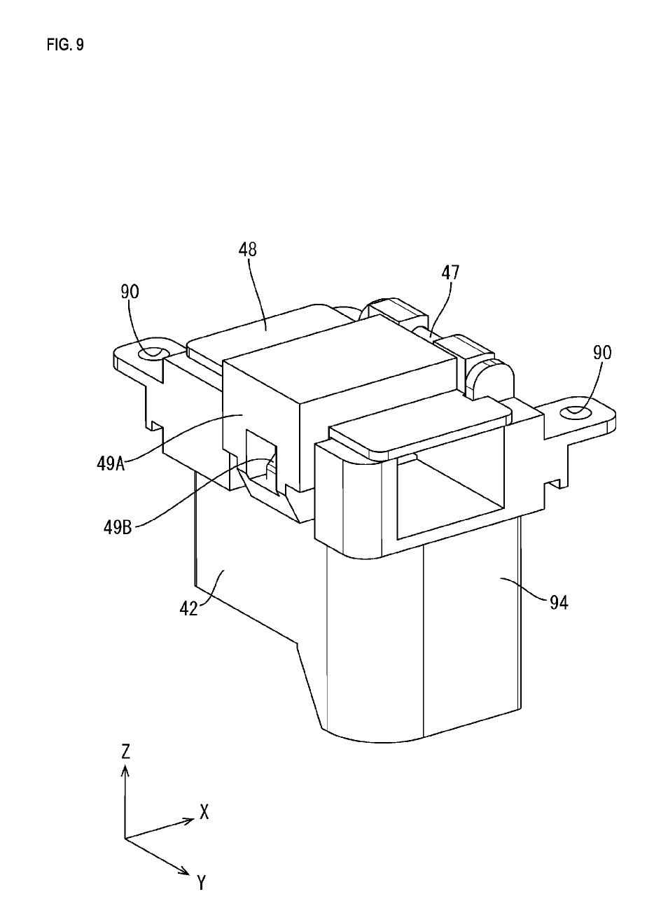

As shown in FIG. 9, the insulation members 42 are made of an insulating synthetic resin. A terminal cover 48, which is made of an insulating synthetic resin, is rotatably attached to each of the insulation members 42 via a hinge 47. The hinge 47 is arranged at a position on the insulation member 42 that is toward the center in the horizontal direction of the heat dissipation member 38. The terminal cover 48 is held in the closed state by elastically locking a lock portion 49A formed in the terminal cover 48 to a lock receiving portion 49B formed on the insulation member 42.

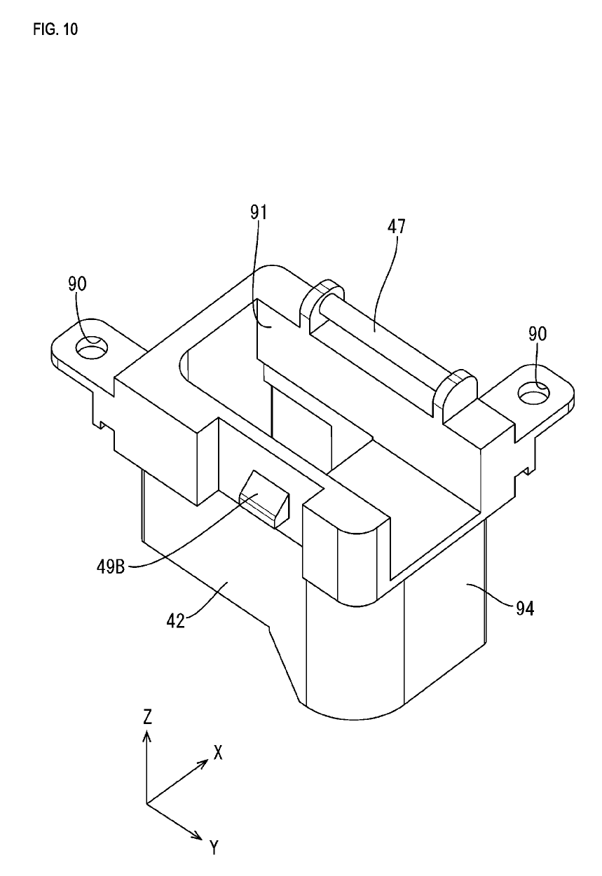

As shown in FIG. 10, insertion holes 90 for insertion of screws 46 are formed extending in the vertical direction in the insulation member 42. Also, a through-hole 91 for insertion of a stud bolt is formed extending vertically in the insulation member 42.

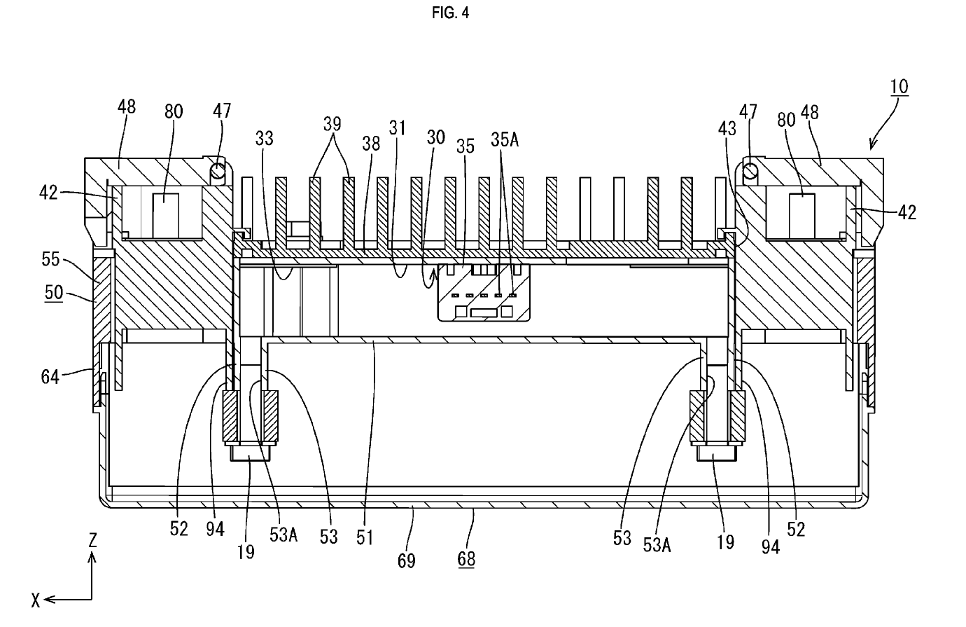

A guide portion 94 that projects downward is formed in a lower end portion of the insulation member 42. The guide portion 94 slides along inner walls of a guide hole 52 formed in the holding member 50, and is housed inside the guide hole 52 (see FIG. 4).

Holding Member 50

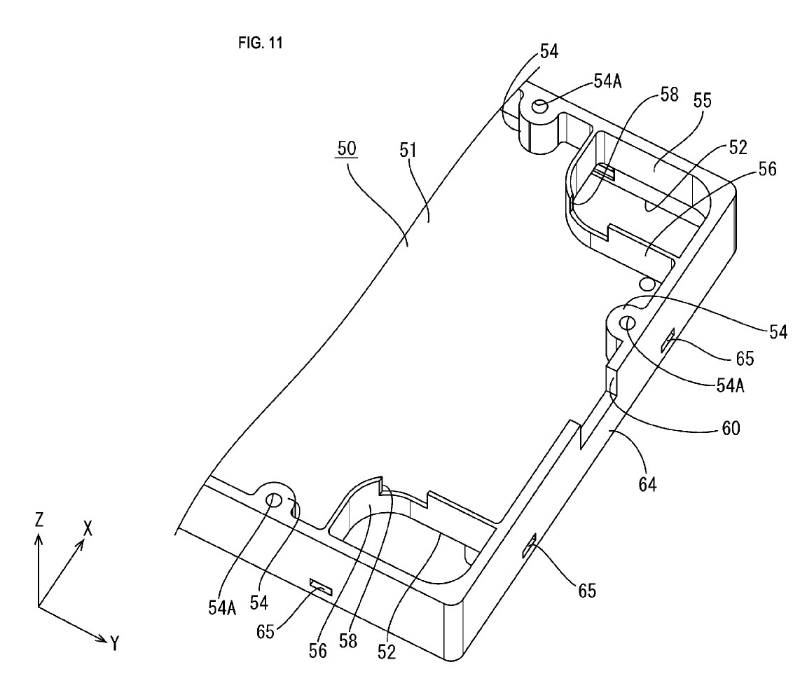

As shown in FIG. 11, the holding member 50 is a made of a metal material such as aluminum or an aluminum alloy, is molded by aluminum die casting for example, and as shown in FIG. 3, includes a rectangular plate-shaped partition wall 51 that is arranged opposing the control portion 30, an upper peripheral wall 55 that extends upward from the peripheral edge portion of the partition wall 51, and a lower peripheral wall 64 that extends downward from the peripheral edge portion of the partition wall 51.

The partition wall 51 is shaped as a rectangle with a size capable of covering the entirety of the control portion 30, and is arranged opposing the control portion 30 with a gap therebetween (see FIGS. 3 to 6). Accordingly, a space is formed between the circuit board 31 and the partition wall 51. Heat generated by the power storage module 11 is not easily transmitted to the circuit board 31 due to the air layer in this space.

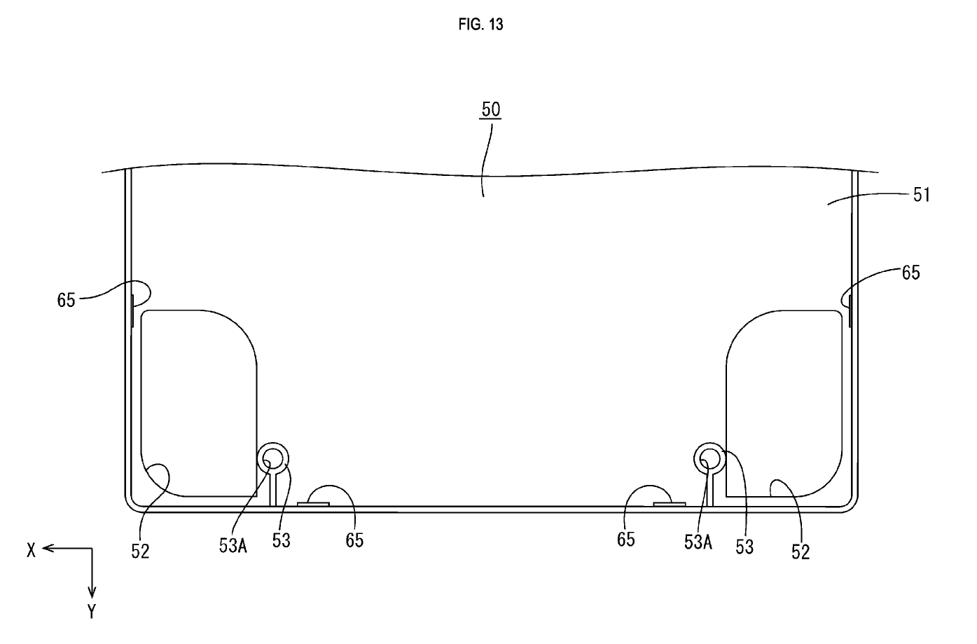

As shown in FIGS. 4 and 13, lower bosses 53 that project downward are formed on the lower surface of the partition wall 51. Threaded holes 53A are formed in the lower bosses 53. The power storage module 11 is fixed to the lower surface of the partition wall 51.

In a state where the power storage module 11 is placed on the lower surface of the partition wall 51 from below, screws 19 are screwed into the threaded holes 53A of the lower bosses 53, thus fixing the power storage module 11 to the partition wall 51.

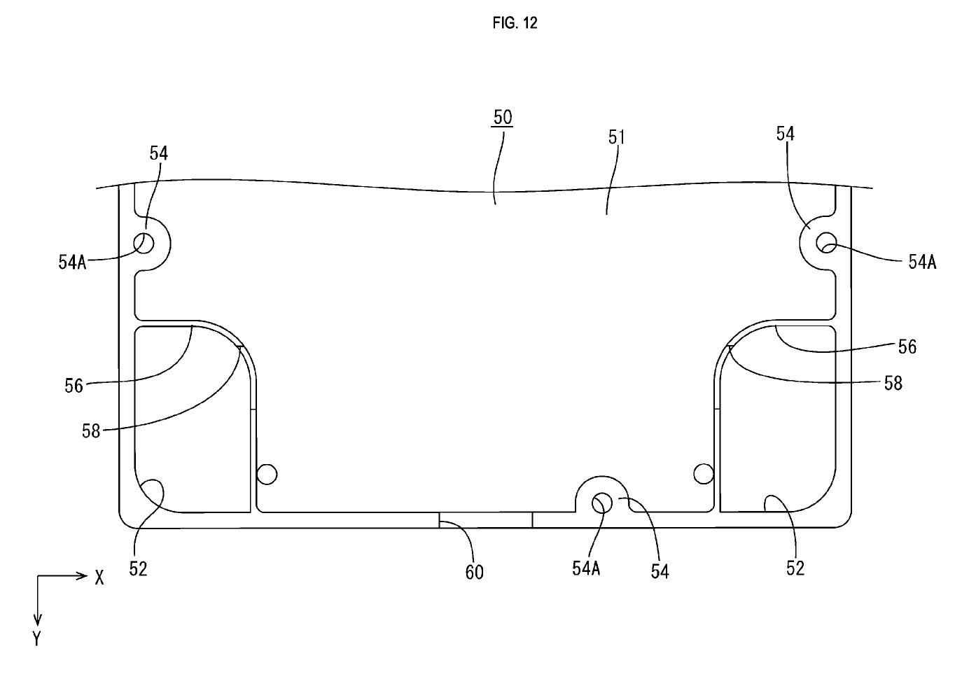

As shown in FIGS. 11 and 12, upper bosses 54 that project upward are formed on the upper surface of the partition wall 51. Threaded holes 54A are formed in the upper bosses 54. The heat dissipation member 38 is fixed to the partition wall 51 by screwing screws 40 into these threaded holes 54A.

Guide holes 52 for insertion of the guide portions 94 of the insulation member 42 are respectively formed in left and right end portions of the front end portion of the partition wall 51. A surrounding wall 56 shaped so as to bulge inward from the inner surface of the upper peripheral wall 55 is formed in the periphery of each of the guide holes 52. Accordingly, the guide hole 52 is surrounded by the upper peripheral wall 55 and the surrounding wall 56 in the front-back and left-right directions.

As shown in FIG. 4, the hold edges of the guide holes 52 and the guide portions 94 slide against each other, and thus the heat dissipation member 38 is arranged at an appropriate position relative to the holding member 50.

As shown in FIG. 11, a recessed portion 58 that is recessed downward is formed in each of the surrounding walls 56. A relay portion 28 is arranged in this recessed portion 58.

An attachment portion 60 for attachment of the connector 35 is formed in the portion of the upper peripheral wall 55 at the front end portion of the holding member 50. The attachment portion 60 is formed as a downward recession in the upper peripheral wall 55.

Cover 68

The cover 68 is made of an insulating synthetic resin, and includes a rectangular plate-shaped bottom wall 69 and side walls 70 that extend upward from the side edges of the bottom wall 69.

Multiple (eight in the present embodiment) frame-shaped locked portions 71 are formed at the upper end edges of the side walls 70. The locked portions 71 elastically engage with locking portions 65 formed at positions corresponding to the locked portions 71 in the lower peripheral wall 64. The cover 68 and the holding member 50 are assembled together due to engagement of the locked portions 71 and the locking portions 65.

Electrical Connection Structure

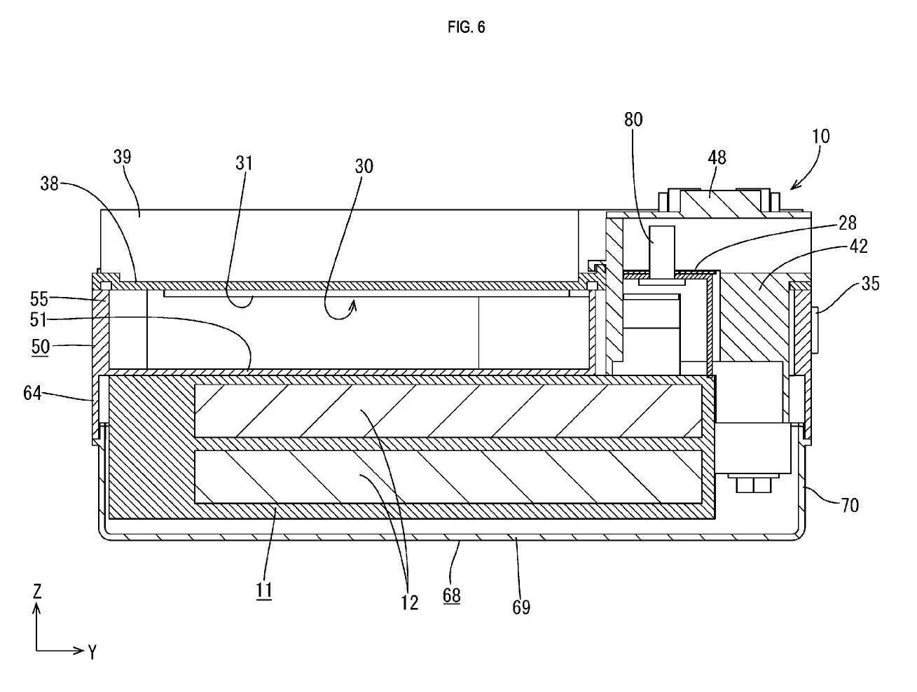

The power storage module 11 is provided with a pair of output terminals 15. The output terminals 15 are electrically connected to electrode terminals (not shown) via the connection member 25. As shown in FIG. 6, the output terminals 15 are each electrically connected to a stud bolt 80.

As shown in FIG. 3, bus bars 33 that project in the horizontal direction from end portions of the circuit board 31 are bent at right angles multiple times, thus forming the relay portions 28. An insertion hole 29 for insertion of the shaft portion of a stud bolt 80 is formed in the end portion of each relay portion 28 on the side opposite to the circuit board 31. The stud bolt 80 is inserted in a state where the relay portion 28 and the output terminal 15 are overlaid on each other.

Terminals (not shown) connected to an external circuit are connected to the stud bolts 80, thus electrically connecting the external circuit to the relay portions 28 and the output terminals 15. Accordingly, the external circuit is electrically connected to the control portion 30 via the relay portions 28. Also, the external circuit is electrically connected to the power storage module 11 via the output terminals 15. The shaft portions of the stud bolts 80 pass through the heat dissipation member 38 and are arranged outside of the heat dissipation member 38.

Also, a connector (not shown) connected to the external circuit is connected to the connector 35, thus electrically connecting the external circuit and the conductive path of the control portion 30.

Note that although the power storage unit 10 is oriented with the heat dissipation member 38 arranged on the upper side in the present embodiment, there is no limitation to this, an orientation in which the heat dissipation member 38 is on the lower side is possible, and the power storage unit 10 can be attached to a vehicle in any orientation as necessary.

The following describes actions and effects of the present embodiment.

The power storage unit 10 according to the present embodiment includes; the power storage module 11 that has multiple power storage elements 12; the heat dissipation member 38; and the stud bolts 80 that electrically connect the external circuit and the power storage module 11, wherein the stud bolts 80 pass through the heat dissipation member 38 and are arranged outside of the heat dissipation member 38.

According to the present embodiment, heat generated by the control portion 30 is transmitted to the heat dissipation member 38. This heat dissipation member 38 is exposed to outside, and therefore heat transmitted thereto from the control portion 30 is efficiently dissipated to the outside. Accordingly, it is possible to improve the heat dissipation capability of the power storage unit 10.

Also, the stud bolts 80 are electrically connected to the heat dissipation member 38 that is exposed to outside, and also pass through the heat dissipation member 38 and are arranged outside of the heat dissipation member 38. Accordingly, the stud bolts 80 are arranged at positions of being reliably exposed to the outside of the power storage unit 10. As a result, it is possible to improve efficiency in the operation of connecting the external circuit and the stud bolts 80.

Also, according to the present embodiment, the power storage unit further includes the control portion 30 that controls charging and discharging of the power storage module 11, the control portion 30 has the connector 35 for connection to an external circuit, and the connection directions of the connector 35 and the stud bolts 80 are the same.

According to the above configuration, the operations of electrically connecting the control portion 30 and the power storage module 11 to the external circuit can be performed from the side corresponding to the heat dissipation member 38 that is exposed to the outside. Accordingly, the operation of electrically connecting the external circuit and the power storage unit 10 can be performed efficiently.

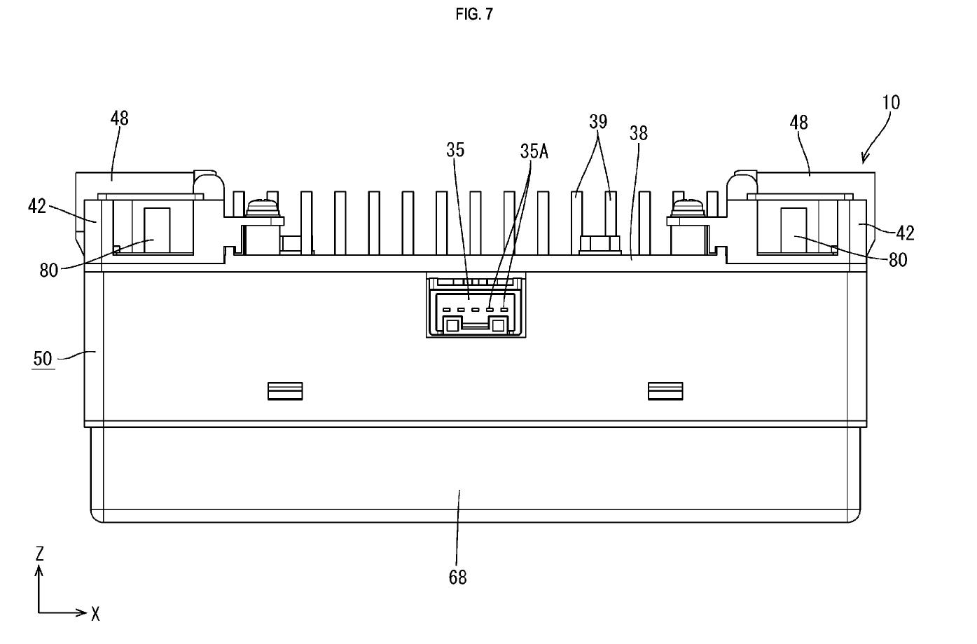

More specifically, a worker can connect the stud bolts 80 and the connector 35 to the external circuit from the front side in FIG. 1 (one example of a connection direction). In FIG. 7, the stud bolts 80 and the connector 35 can be seen from the front side. For this reason, the worker can perform the operation of electrically connecting the external circuit and the power storage unit 10 from one side (the front side in the present embodiment).

Also, in the present embodiment, the control portion 30 includes the relay portions 28 that are connected to the stud bolts 80.

According to the above configuration, the control portion 30 and the power storage module 11 can be electrically connected by connecting the stud bolts 80 and the relay portions 28.

Also, according to the present embodiment, the through-holes 43 that pass through the heat dissipation member 38 are formed in the heat dissipation member 38, the insulation members 42 that are made of an insulating material are attached inside the through-holes 43, and the stud bolts 80 and the heat dissipation member 38 are electrically insulated from each other by the insulation members 42.

According to the above configuration, the stud bolts 80 and the heat dissipation member 38 can be reliably insulated from each other.

Also, according to the present embodiment, the heat dissipation member 38 is assembled together with the holding member 50, and the insulation members 42 have the guide portions 94 that guide the heat dissipation member 38 to an appropriate position relative to the holding member 50 by sliding against the holding member 50.

According to the above configuration, the relatively heavy heat dissipation member 38 can be easily attached to the holding member 50.

Also, according to the present embodiment, multiple (two in the present embodiment) insulation members 42 are provided, the insulation members 42 are provided with the hinges 47, the terminal covers 48 that cover the stud bolts 80 are attached to the hinges 47, and the hinges 47 are provided at positions on the insulation members 42 that are toward the center of the heat dissipation member 38.

According to the above configuration, the terminal covers 48 expose or obstruct the stud bolts 80 by rotating about the hinges 47 that are arranged at positions on the insulation members 42 that are toward the center of the heat dissipation member 38. According to the present embodiment, the rotation axes of the terminal covers 48 are provided toward the center of the heat dissipation member 38, thus facilitating the operation of opening and closing the terminal covers 48, which makes it possible to improve efficiency in the operation of connecting the stud bolts 80 to the external circuit.

### Other Embodiments

The present invention is not intended to be limited to the embodiments described using the above descriptions and drawings, and the technical scope of the present invention also encompasses various embodiments such as the following, for example.

Although the control portion 30 includes the one circuit board 31 in the embodiment, two or more circuit boards may be used.

Although the holding member 50 is made of a metal in the embodiment, it may be made of a synthetic resin, and any material can be selected as necessary.

Although the cover 68 is made of an insulating synthetic resin in the embodiment, it may be made of a metal.

Although the power storage elements 12 are cells in embodiment, there is no limitation to this, and they may be capacitors.

Although four power storage elements 12 are included in one power storage unit 10 in the embodiment, there is no limitation to this, and two to three, or five or more may be included.

The connector 35 may be omitted.

The guide portions 94 may be omitted.

A configuration is possible in which the hinges 47 are provided at any position on the insulation members 42.

1. A power storage unit comprising:
a power storage module that includes a plurality of power storage elements;
a heat dissipation member that is overlaid on the power storage module; and
an external connection terminal that electrically connects an external circuit and the power storage module,
wherein the external connection terminal passes through the heat dissipation member and is arranged outside,
a through-hole that passes through the heat dissipation member is formed in the heat dissipation member, an insulation member made of an insulating material is attached inside the through-hole, and the external connection terminal and the heat dissipation member are electrically insulated from each other by the insulation member,
a plurality of the insulation members are provided,
the insulation members are each provided with a hinge, and a terminal cover that covers the external connection terminal is attached to each of the hinges, and
the hinges are provided at positions on the insulation members that are toward a center of the heat dissipation member.

2. The power storage unit according to claim 1,
further comprising a control portion that controls charging and discharging of the power storage module,
wherein the control portion includes a connector for connection to the external circuit, and connection directions of the connector and the external connection terminal are the same.

3. The power storage unit according to claim 2, wherein the control portion includes a relay portion that is connected to the external connection terminal.

4. (canceled)

5. The power storage unit according claim 1,
wherein the heat dissipation member is assembled together with a holding member, and
the insulation member has a guide portion that guides the heat dissipation member to an appropriate position relative to the holding member by sliding against the holding member.

6. (canceled)

7. The power storage unit according claim 2, wherein the heat dissipation member is assembled together with a holding member, and the insulation member has a guide portion that guides the heat dissipation member to an appropriate position relative to the holding member by sliding against the holding member.

8. The power storage unit according claim 3, wherein the heat dissipation member is assembled together with a holding member, and the insulation member has a guide portion that guides the heat dissipation member to an appropriate position relative to the holding member by sliding against the holding member.
